(19) United States
(12) Patent Application Publication
(10) Pub. No.: US 2014/0085085 A1
(43) Pub. Date: Mar. 27, 2014

(54) Audio and Light Fungal Growth Indicator

(71) Applicant: Thomas Paul Cogley, Sr., Pinellas Park, FL (US)

(72) Inventor: Thomas Paul Cogley, Sr., Pinellas Park, FL (US)

(73) Assignee: Dr. Thomas Paul Cogley, Pinellas Park, FL (US)

(21) Appl. No.: 13/627,244

(22) Filed: Sep. 26, 2012

(51) Int. Cl. G08B 21/00

(52) U.S. Cl. 340/540

(57) ABSTRACT

A device was invented with a sensor that would allow for determining fungal growth. When fungal growth occurs the sensors would be activated emitting audio, light and actual voice commands. The device provides; a low cost, simplicity of use and function, and its ability to fulfill a need for the means to determine growth of fungi placed behind closed doors or beyond the point of view.

This device may be used for pathogenic fungal growth in medical and veterinary facilities, also in laboratories examining environmental pollution. The automatic sensing methodology also allows for a reduced chance for the preparer to be contaminated through exposure by reducing the need of continual examination of the fungal growth.

### HISTORY

The most common fungal condition is known as ringworm caused by several types of fungi. Ringworm is of importance in man and animals where it may spread and cause clinical signs and symptoms. It is a medical condition that may be infectious, painful and leave scars. Veterinarians and microbiologists utilize special media to determine if a sample taken from the body of a patient has fungal activity. The media used is called DTM or Dermatophyte Testing Media. It is provided in a glass jar or small petri dish is Horizontal. Growth of the fungus is enhanced in this media over bacterial growth. With growth the media turns red and a colony will form. The problem occurs in that the DTM growth occurs over days and very busy people are required to monitor growth during this time. In addition an important factor is that the media is normally placed out of sight behind closed doors in the dark. Out of sight often means out of mind and media is often forgotten of not looked at everyday. If the media is forgotten a bacterial overgrowth may occur sometimes hiding the original or destroying the original fungal growth through metabolites excreted by the late invaders. The color change of an old contaminated media may occur through bacterial action and give a false negative.

### BACKGROUND OF THE INVENTION

Today health providers and microbiologists use a colorimetric indicator, phenol red, in a media that promotes the growth of several medically important dermatophytes or fungi. As they grow their alkaline metabolites will cause a color change in the media due to the phenol red. This indicator is useful to show the difference in PH and therefore growth possibilities of fungus. The media used today called dermatophyte test medium (DTM) changes from orange/yellow slightly opalescent turns pink to red if positive for fungi such as Trichophyton or Microsporum. A white cotton—like growth will usually form on the surface of the media.

This invention utilizes sensor(s) will sense changes in color and surface object size(s) in DTM that would indicate fungal growth from clinical samples placed on said media. Sensors, such as, but not limited to, photoelectric sensors, will detect such changes in the media that is kept at a remote sight where growth is optimized but unfortunately out of sight from the tester during typical daily functions.

The invention also includes any type of sensor or device other than one's eye. The sensor selected will be of a type that can sense color change and particulate matter and may utilize sensing modes such as Diffuse; Retro-Reflective; or transmitted beam but not limited to this categories only. Specialty sensing devices may also be incorporated to remove limitations of color changes or particular numbers or sizes of the fungal colonies.

The indicating devices will be energized when the particular sensing modes used create output from the sensors. The sensing criteria will be based on growth of the fungus in the DTM media from a clinically obtained particulate placed in the media. Indicators of growth monitored by the sensor(s) include but are not limited to 1) A color change and 2) Particulate expansion in size. The first of two indicating devices is a light indicator placed on a surface outside of the incubatory area and in sight of the tester or personnel. The second is a micro-recorder player that will give an audio indication at prescribed intervals. This device placement is in or outside of the incubatory area. Other means to indicate that the sensors have an output hence an indication of color change or particulate growth for example are also part of the invention and should not be limited to that which was given by example. Such outputs could include PNP, NPN, SPDT, RELAY, and MOSFET including Analog Modality as indicators. Further benefits of the invention include its ability to continuously monitor growth of fungus on the media during the period of days or weeks required to monitor growth. Furthermore, the sensors used to detect growth on and color change in the media will do so at levels beyond that capable of the human eye and hence early development of fungi can be detected than presently possible. The likelihood of handlers be contaminated by infective fungi is reduced since the handling time required by humans in monitoring the media is greatly reduced over the present. Personnel will need to touch sample vials only upon the first day and when sensors indicate growth. The need to enter the confines of the incubatory area on a daily basis is not necessary unless a sensor indicates growth. This invention greatly increases performance of being able to determine fungal growth over the period of time required.

### SUMMARY OF THE INVENTION

This invention enhances the present situation for determining fungal growth of clinical samples. Specifically, fungal growth 1) Kept in a remote area are continuously tracked through various modalities; 2) An audible and a visual indicator are used to indicate growth; 3) The sensitivity of detecting early growth by the sensors is increased beyond that possible utilizing only the naked eye, and 4) the likelihood of handlers be contaminated by infective fungi is reduced due to the lessened handling time required by humans in monitoring the media.

### BRIEF DESCRIPTION OF THE DRAWINGS

FIG. 1

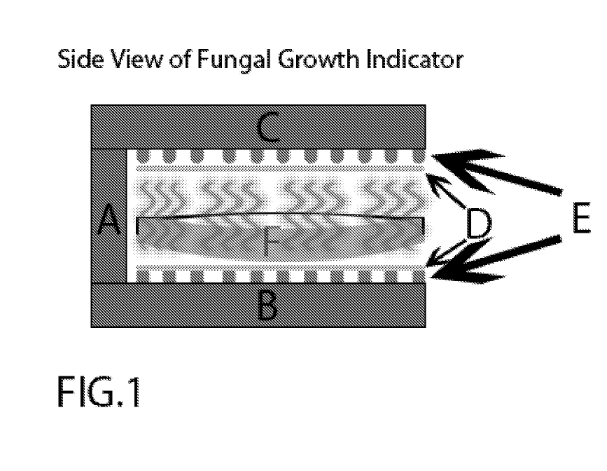

A=Pillar to hold wires and the top up.

B=Bottom that holds light sensors.

C=Top that holds light sensors.

D=Glass or plastic protective layer

E=Optic Electric Sensors

F=Petri Dish

FIG. 2

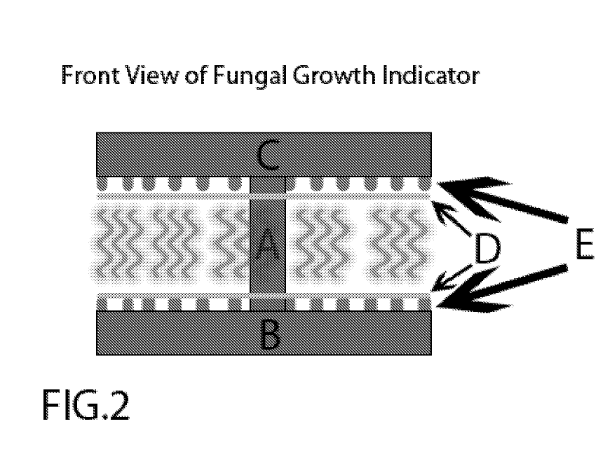

A=Pillar to hold wires and the top up.

B=Bottom that holds light sensors.

C=Top that holds light sensors.

D=Glass or plastic protective layer

E=Optic Electric Sensors

FIG. 3

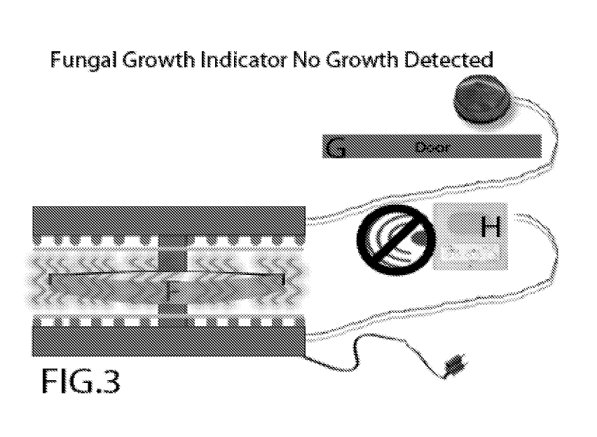

F=Petri Dish

G=Lab Partition or Door

H=Microphone that will speak a phrase that indicates growth

FIG. 4

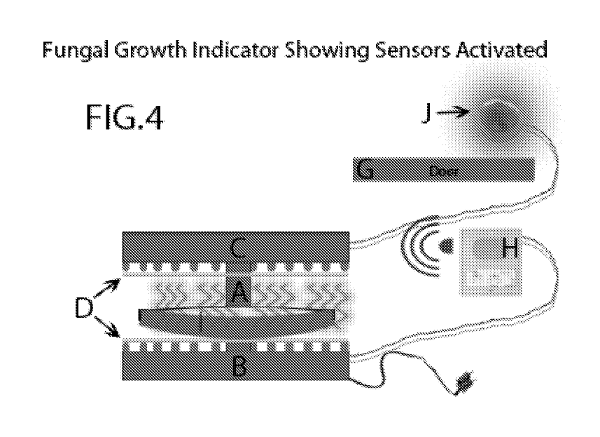

A=Pillar to hold wires and the top up.

B=Bottom that holds light sensors.

C=Top that holds light sensors.

D=Glass or plastic protective layer

G=Lab Partition or Door

H=Microphone that will speak a phrase that indicates growth

I=Petri Dish turned red indicating fungal growth

J=Light Outside the partition or door which is lit indicating fungal growth

What the invention claimed is:

1. An Audio Fungal Growth Indicator for a DTM Petri Dish.

2. An invention as in claim 1 utilizing recorder verbal instructions or demands.

3. An invention as in claim 1-2 however instead of audio notification it notifies by the use of a blinking light.

4. A similar invention as in claim 3 however the notification light is steady instead of blinking.

5. A similar invention as in claim 3-4 however it has both audio and light notification.

6. A similar invention as in claim 1-5 but with any form of light wavelength on the Electro Magnetic Spectrum (EMS) reflecting through the DTM.

7. A similar invention as in claim 1-6 but with plastic or glass over the lights protecting the petri dish.

8. An invention as in claim 1-7 that utilizes a power cord as a source of power.

9. An invention as in claim 8 however instead of utilizing a power cord it utilizes any form of batteries.
